(19) United States
(12) Patent Application Publication
(10) Pub. No.: US 2022/0253889 A1
(43) Pub. Date: Aug. 11, 2022

(54) INCORPORATING A PRODUCT IN A MULTI-LEVEL SMARTLINK EMBEDDED MEDIA FILES FOR ENHANCED MARKETING

(71) Applicant: KwikClick, LLC, Murray, UT (US)

(72) Inventor: Fred Cooper, Farmington, UT (US)

(21) Appl. No.: 17/587,777

(22) Filed: Jan. 28, 2022

Related U.S. Application Data
(60) Provisional application No. 63/142,945, filed on Jan. 28, 2021.

(51) Int. Cl. G06Q 30/02; G06F 16/955

(52) U.S. Cl. CPC G06Q 30/0236; G06Q 30/0201; G06F 16/9558; G06F 16/9566

(57) ABSTRACT

The present disclosure is directed to a system and method to allow sellers of products to create and share marketing materials with other individuals. A member of an MLM organization may create a photo or a video of themselves using a product after which that member may associate an image of the product in the photo or video with a link to an offering to purchase the product. This process may include embedding a link within an image that can be selected by a user pointing and clicking on the product or by the user touching the product when the image of the product is displayed on a touch screen display. After a user purchases the product offered for sale, one or more related users may receive commissions based on a relationship that ties the related users to the sale of the product.

### CROSS-REFERENCE TO RELATED APPLICATION

The present disclosure claims priority benefit of U.S. provisional patent application 63/142,945 filed on Jan. 28, 2021, the disclosure of which is incorporated herein by reference.

### BACKGROUND OF THE INVENTION

### Field of Invention

The present disclosure is generally related to multi-level systems and methods for embedding smartlinks. More specifically, the present disclosure is directed to providing smartlinks for multi-user tracking.

### Description of the Related Art

A Multilevel marketing (MLM) commission payment system is a sales methodology used by some direct sales companies, which may be used to encourage existing distributors to recruit new distributors who are paid a percentage of their recruits' sales. The recruits are “downline” of the distributors. The term “downline” is used to describe sellers of products that have been sponsored by a sponsor (i.e. a sponsee of the sponsor) to sell products. The term “upline” is used to refer to sellers of products that sponsored a given sponsee. As such, sponsors are distributors that are upline from their sponsees and sponsees are distributors that are downline from their sponsors. Distributors also make money through direct sales of products to customers. Amway, which sells health, beauty, and home care products, is an example of a well-known direct sales company that uses multilevel marketing.

Multilevel marketing (MLM) has been found to be a legitimate business sales methodology if participants receive something of value for their participation in an MLM organization. Even though Amway has a pyramid like structure where sponsors may receive more benefits than new recruits, Amway has been judged to be a legitimate organization because all participants receive the benefit of purchasing products at a competitive price. One problem with some MLM organizations referred to as “pyramid schemes” where new recruits do not receive any benefit based on just joining the MLM organization. One characteristic of a MLM “pyramid scheme” versus a legitimate MLM organization is that in a “pyramid scheme” new recruits receive benefits based primarily from signing up other new participants. Thus, money received from the new recruits only pays people above them or at the top of the organization rather than new recruits or others who actually perform work (e.g. the selling of products). As such, a “pyramid scheme” is also characterized by paying sponsors rather than individuals that perform the work. This is why “pyramid schemes” are illegal. These “pyramid schemes” involve taking advantage of people by pretending to be engaged in legitimate multilevel or network marketing activities, when their greater focus is on recruitment rather than on product sales.

One issue in determining the legitimacy of a multilevel marketing company is whether it sells its products primarily to consumers or to its members who must recruit new members to buy their products. If it is the former, the company is likely a legitimate multilevel marketer. If it is the latter, it could be an illegal pyramid scheme.

Each MLM company dictates its own specific financial compensation (or commission) plan for the payout of any earnings to their respective distributors. Compensation may be in the form of commissions that require a participant to enter a contract, pledging exclusivity in participation to the MLM company paying the commissions. Compensation plans of MLMs pay out to participants typically from two primary possible revenue streams. The first is paid out from commissions of sales made by the participants directly to their own retail customers. Retail customers are not tracked or known by the MLM company, therefore, MLM companies cannot substantiate either their existence or their sales volume individually or collectively. The second is paid out from commissions based upon the wholesale purchases made by other distributors below the participant who have recruited those other participants into the MLM; in the organizational hierarchy of MLMs, these participants are referred to as one's downline distributors.

MLM salespeople (distributors) are, therefore, expected to sell specific MLM company products directly to end-user retail consumers by means of relationship referrals and word of mouth marketing, but most importantly they are incentivized to recruit others to join the company's distribution chain as fellow salespeople so that these can become downline distributors.

Currently, no large financially successful MLM salesperson (distributor) can earn commissions of any significance or take full advantage of a commission compensation plan without personally recruiting others into their downline.

All MLM compensation companies permanently place new recruits in a tree structure for calculating commissions. Once placed, all sales made by that distributor from their personal purchases, or from new recruits they sponsor, generate commissions only for their sponsor and upline, regardless of all future products sold.

MLM companies offer goods or services offered specifically and exclusively by them. The large markups required for payment of commissions necessitate MLM companies to limit what products they can offer such that they will be financially indifferent regarding which product a distributor chooses to buy.

MLM companies currently have a “pay to play” requirement. Distributors are required to make monthly purchases, and/or meet downline group sales volumes to qualify for commissions. Thus the mode, median and average purchase size of a distributor in MLMs is virtually equal to this minimum qualification requirement and no greater.

Distributors only qualify for commissions if they have purchased a minimum threshold of products offered exclusively by the MLM company as set forth by an MLM company's commission program rules.

Currently, in order to join an MLM organization, there is an initiation fee, which may be a barrier against those that just wish to refer a single product they like. Current multi-level marketing (MLM) systems do not take full advantage of the internet and how consumers can influence other consumers to make purchases. Also, current MLM systems do not incorporate incentivizing users of a multilevel marketing system by offering a dynamic commission tree. In addition, there is no current MLM system that utilizes the money or funds dedicated to discounts or coupons to be reincorporated into a multilevel marketing system to incentive consumers to make purchases and advertise the product that they purchased. Thus, there is a need to provide users a method to join an MLM for free, being simple to use and allow the MLM commissions provided to purchasers, provided by the sellers to allow the purchasers to market the seller's products.

Currently, a company that is not utilizing an MLM structure for paying commissions for sales, cannot introduce one without developing a compensation plan specific for their company, following the methodology outlined above, and thus requiring them to become and subsequently adhere to applicable MLM law.

Current MLM organizations also do not allow their members to create marketing materials that may help motivate other individuals to join the MLM organization or to motivate members to purchase products offered for sale by the MLM organization. What are needed are new types of systems and apparatus that allow MLM members create and share marketing materials.

Further, there is currently no systematic way for consumers to promote any brand of preference outside the MLM industry and be paid in an MLM commission methodology without subjecting themselves to a contractual signup, initiation fee's, minimum recurring purchases sales, volume requirements, recruiting, exclusivity, and permanent tree placement (resulting in only upline distributors earning commissions).

### SUMMARY OF THE CLAIMED INVENTION

The presently claimed invention is directed to a method that may be implemented as a non-transitory computer-readable storage medium. In one embodiment, a method includes receiving data from a user device that includes an image of a product. The user device from which that data is received from may be associated with a user identifier (ID). After this data is received, it may be stored at a database with data that associates the user ID, the product, and a follower code. This method may also include updating the received data to include an embedded link in the received data such that an offering for the product can be accessed based on selection of the embedded link, sending the received data with the embedded link to the user device, and distributing commissions after an order for the product has been fulfilled. The commissions may be distributed based on the receipt of information that identifies the user ID, the product, the follower code, and the fulfillment of the product order.

In another embodiment, a processor may execute instructions out of a memory when the method is implemented as a non-transitory computer readable storage medium. Here again the method may include receiving data from a user device that includes an image of a product. The user device from which that data is received from may be associated with a user identifier (ID). After this data is received, it may be stored at a database with data that associates the user ID, the product, and a follower code. This method may also include updating the received data to include an embedded a link in the received data such that an offering for the product can be accessed based on selection of the embedded link, sending the received data with the embedded link to the user device, and distributing commissions after an order for the product has been fulfilled.

### BRIEF DESCRIPTION OF THE DRAWINGS

FIG. 1 illustrates a system for Multi-Level Marketing of products via a set of computing devices.

FIG. 2 illustrates steps that may be performed by an administration computer that receives media file data from user devices after members of a multilevel marketing system have generated content to share with others.

FIG. 3 illustrates actions that may be performed when a user wishes to include hyperlinks in a media file or when the user wishes to update hyperlinks in a media file.

FIG. 4 illustrates a method that may be performed by a computer at the third party network computer of FIG. 1.

FIG. 5: Illustrates a computing system that may be used to implement an embodiment of the present invention.

### DETAILED DESCRIPTION

The present disclosure is directed to a system and method to allow sellers of products to create and share marketing materials with other individuals. These materials may be used to enroll an individual product in a multilevel marketing (MLM) system, where the product is offered and sold to a first purchaser—who can enroll as a registered MLM user. Members of an MLM organization may create media files that include images, videos, or other materials that promote the sale of a product. A member of an MLM organization may create a photo or a video of themselves using a product after which that member may associate an image of the product in the photo or video with a link to an offering to purchase the product. This process may include embedding a link within an image that can be selected by a user pointing and clicking on the product or by the user touching the product when the image of the product is displayed on a touch screen display. Links may be shared automatically or manually depending on the referrer's preference. After a user purchases the product offered for sale, one or more related users may receive commissions based on a relationship that ties the related users to the sale of the product.

As used herein, links may refer to pointers that point to a webpage. For example, a link may be inclusive of a hyperlink, uniform resource locator (URL), quick response (QR) code, etc., associated with a webpage. Once a link is embedded within digital media and/or associated with additional information, the link may be referred to as an embedded link or smart-link.

The present disclosure is also directed to a system and method to allow sellers of products to enroll an individual product in a multilevel marketing (MLM) type commission system (system), where a good or service (i.e. product) is offered by any vendor and sold to a first purchaser—who at the time of the purchase becomes a system user (or registered user/participant). This user has a code tied to the specific product(s) offered by the participating vendor. The code may be shared by this first user passively (by a purchase) or actively (by request) to a new buyer. The code share makes the new buyer a user of the system. The new user, like the first, will be allowed to purchase the product and provide advertisements to other purchasers. Commissions paid to respective downline purchasers for a single product may be limited by a preset number of defined levels. After a product is purchased, commissions are paid out to each respective purchaser according to the defined commission levels. A wave of creating and recreating users may be based on purchases and linking them together may be part of an iterative process. Remuneration on this specific product is paid to all or numerous users linked together in the system, each time a purchase is made. The links may be unique and fixed to each good or service being referred.

In certain instances, a registered MLM member or user may be provided a code tied to the purchased product such that the code may be passed onto followers of the registered user. The registered user may be allowed to advertise the product to a second purchaser and the second purchaser will be allowed to purchase the product and provide advertisements to other purchasers. Here again commissions paid to respective downline or upline purchasers for a single product may be limited by a preset number of defined levels. After a product is purchased, commissions are paid out to each respective purchaser according to the defined commission levels.

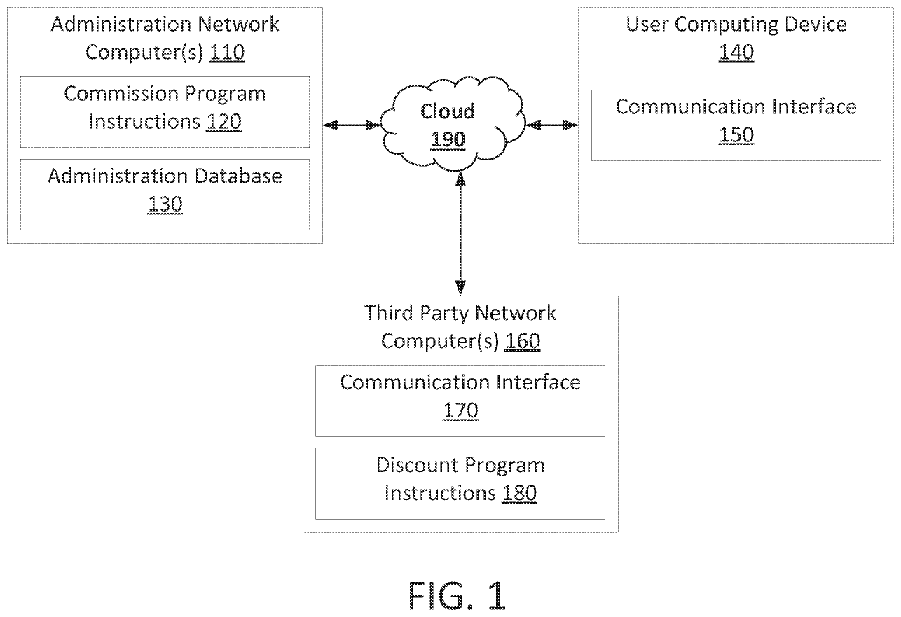

FIG. 1 illustrates a system 100 for Multi-Level Marketing of products via a set of computing devices. The system of FIG. 1 includes an administration computer or “administration network” computer 110, a user computing device 140 (user device), and a third party network computer 160. Each of the devices of FIG. 1, the administration network computer 110, the third party network computer 160, and user device 140 may communicate with each other via the communications network 190 such as the Internet or a cloud.

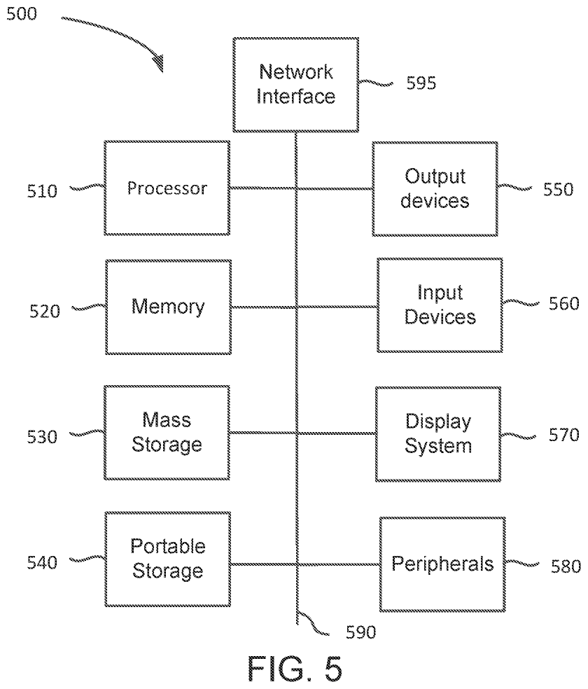

A memory, as shown in FIG. 5, at the administration network computer 110 may store commission program instructions 120 executed by a computer processor, and an administration database 130. User device 140 of FIG. 1 may be any user device such as a laptop, smartphone, tablet, computer, or smart speaker which may include a user device communication interface 150 which may be a network interface as shown in FIG. 5. The third party network computer 160 of FIG. 1 may include discount program instructions 180 executed by a computer processor, a memory, and a communication interface 170 which may be a network interface.

Use of the system may be as follows. A user connects a user device 140 to the communication network 190 via the user device communication interface 150. Communications may be sent through the communication network 190 the user device 140 may then connect with the third party network computer 160 via the third party network communication interface 170. A set of third party network discount program instructions 180 allow the user to purchase a product from the third party network computer 160 and apply a discount to the product if a user has a code. Confirmation of the purchase and the code are then sent from the third party network computer 160 to the administration network computer 110. If the user did enter a code, a set of administration network commission program instructions 120 will pay commission to at least another user that is associated with the code. A new code is then generated by the administration network 110 per the administration network commission program instructions 120. The new code is associated with the user of the user device 140. The commission and the newly generated code are stored in the administration network administration database 130. This process may also allow a user to provide media files and link products included in those media files to promotional offerings for products illustrated in the promotional media files. After a user has created a media file, that file may be shared with their followers and the user may receive commissions when one of their followers purchases a product. A follower may have purchased the product after viewing a video or photo illustrated in the media file created and shared by the user. Followers that share the media file that they received from the user may also earn commissions when subsequent “downline” followers purchase the product illustrated in the media file.

Program code instructions of the administration network computer 110 may be organized as one or more software modules that include instructions for performing different functions. For example, a set of commission program instructions 120 may include base program instructions, advertising program instructions, calculation program instructions, and vendor program instructions. The administration network computer 110 may also access one or more databases, such as a compensation database that stores compensation data and a code database that stores program code or web link data, for example. The administration network computer 110 may accept sellers (third parties), where a “single product tree” multi-level marketing method is formed, comprising the steps of, providing at least one product, providing an MLM system with a seller's commission structure, and providing at least one seller of a product with its associated commission structure. The term “single product tree” refers to a unique structure for associating distributors of an MLM organization where products are used to identify relationships between distributors and commissions paid to related distributors. This “single product tree” structure allows for a particular user to be considered a sponsor or any other user based on that user sending promotions to other users to purchase a product that those other users were not previously associated with.

The administration network computer 110 may also provide a plurality of buyers/distributors, allow the at least one first seller to enroll a product to the MLM system, and allow at least a first buyer/distributor to purchase the product. Other functions that may be performed by the administration network computer 110 include allowing at least the first buyer/distributor to advertise the product to other potential buyers/distributors and allowing at least a second buyer/distributor to buy the advertised product. Here the seller may set a commission structure for a product, may enroll the product into the MLM system, may allow the first, second and so on purchasers/distributors to purchase and advertise the product.

Once products have been enrolled with a commission structure, the administration network computer 110 may allow the purchasers/distributors to receive a commission based upon the seller's product commission structure. A distributor may refer to the non-salaried workforce selling the company's products or services. Here the earnings of the participants may be derived from a pyramid-shaped or binary compensation commission system. The term product may refer to articles or substances manufactured or refined for sale. Product may refer to an individual product, a line of products such as unique brand and model of drill, or a group of products such as all power tools. A service may refer to a system supplying a public need such as transport, communications, or utilities such as electricity or water.

A service which may be an act of dealing with a customer in a store, restaurant, or hotel by taking their orders, showing, or selling them goods. Additionally, a service which may be work that someone does or time that someone spends working for an organization, or a business that offers a particular type of help or work. The system 100 of FIG. 1 may distribute commissions according to an MLM tree or commission tree that is a payment structure in which commissions are given out at different percentages at different levels of the MLM tree, for example. In such a system, distributors (users) that perform the sale or that are at a level that is “closer” to the distributor that performed the sale may receive larger commissions than distributors that are “farther” from the sale.

In another example, a first MLM distributor that performs a sale may receive a higher percentage than a second distributor that sponsored the first distributor, and a third distributor that signed up the second distributor may receive a lower commission than the commission received by the second distributor for the sale. Distributors in an MLM tree may be referred as “downline” or “upline” distributors depending on where different users rank on the MLM tree. For example, a first user that sponsors a second user is “upline” from the second user and the second user is “downline” from the first user in the MLM tree. Furthermore, any user/distributor that the second user sponsored would be considered downline from the second user and could be downline from the first user as well for a given MLM product tree. When a “single product tree” structure is used to identify commissions, users that are downline from the second user may not be downline from the first user based on the second user purchasing and advertising products not associated with the first user. When the first user purchases the product initially advertised by the second user, the second user may be considered upline of the first user after the first user for this product. Because of this, the second user is not relegated to always be downline from the first user just because the first user originally sponsored the second user to become an MLM distributor.

An MLM system which may be referred to as network marketing, may be a business model that depends on person-to-person sales by independent representatives, who may work from their home. A network marketing business may require the independent representatives to build a network of business partners or salespeople to assist with lead generation and closing sales. End of life of MLM tree may refer to the end of the MLM tree in which the commission tree may be restructured or eliminated. For example, participants that are more than some number of steps (e.g. 5) away from a sale in the MLM may not receive a commission, the commission tree may “start up” (be reinitiated from a starting point) again, or the commission tree may be restructured in some other way. An existing MLM system may refer to currently existing or established companies that use the sales strategies to encourage existing distributors to recruit new distributors who are paid a percentage of their recruits' sales.

The administration network computer 110 may perform data security functions as well as functions associated with operation of an MLM algorithm that may calculate user compensation. Administration network computer 110 may be able to connect to a software application store, like the “Apple App Store,” where a program application can be downloaded from. Data security may refer to the process of protecting data from unauthorized access and data corruption throughout its lifecycle. Data security may include data encryption, tokenization, and key management practices that protect data across all applications and platforms. An MLM algorithm may refer to a calculation performed using a compensation decay rate to calculate the commissions for downline or upline participants.

The commission program instructions 120 of FIG. 1 may cause a computer processor in the administration network computer 110 to continuously poll for user data (e.g., data of a user who may be a product purchaser or product distributor) from another processor executing a set of discount program instructions 180 at a third party network computer 160. Once the processor of the administration network computer 110 receives the user data, commissions may be calculated using the commission program instructions 120 of FIG. 1. These commissions may be calculated based on data stored in an administration network compensation database. Downline and upline commissions for the other users (product purchasers/distributors) within the MLM tree may be paid. The administration network compensation database may be included within the administration database 130 of FIG. 1 or it may be a separate database accessible by the administration network computer 110. Alternatively, instead of the administration network computer 110 polling a third party network computer 160, the third party network computer 160 may send the user data to the administration network computer 110 after a sale has been made.

An upline may refer to the MLM distributors that recruits work for as salespeople to sell the products or services. A downline may refer to the recruits the MLM distributors are able to secure as participants in the MLM system. Downline MLM trees may go across country boundaries and commissions may be paid out for an MLM tree even though the participants in the MLM tree may not reside in the same country. The commissions may be calculated for the appropriate exchange rate to ensure participants are paid in their residing countries currency in the correct amount.

A processor executing the commission program instructions 120 of FIG. 1 may continuously poll for user data from the third party network computer 160. The administration network computer 110 may then receive the user data from the third party network computer 160. Then the administration network computer 110 may determine whether the user entered a code. If the user did enter a code, the processor at the administration network computer 110 may extract the code and then access the administration network compensation database to identify one or more different spheres of influence or potential product purchasers/distributors levels. Such a code may have been received from user device 140 based on user inputs. A sphere of influence for a given product may be associated with a chain of upline and downline distributors that sold a particular product, where each downline user may have been sponsored to sell the product by an upline user.

The processor at the administration network computer 110 may also associate a code for each of the different spheres of influence. The administration network computer 110 may then extract a corresponding commission for the code that was retrieved from in the administration network compensation database. The administration network computer 110 may then send the commission to the user (purchaser/distributor). The administration network computer 110 may track profits and payments as well as track taxes for users enrolled in the MLM system. The tracking of profits and payments may refer to the MLM system tracking the profits of the MLM and tracking the payments or commissions paid out to participants. The tracking of taxes may refer to tracking the commissions provided to participants for tax purposes. Then the administration network computer 110 may also compare the extracted code to data stored at an administration network code database a list of users and code sent to followers may be stored. This administration network code database may be the same database as the administration database 130 of FIG. 1 or it may be another database accessible by the administration network computer 110. The administration network computer 110 may extract a user ID and sphere of influence or potential purchaser/distributor by using the extracted code.

The administration network computer 110 may then compare the extracted sphere of influence or potential purchaser/distributor to data stored at the administration network compensation database. The administration network computer 110 may then use the extracted sphere of influence data to extract a corresponding commission from the administration network compensation database. The administration network computer 110 may then send the commission to an upline user. If the user did not enter a code, the administration network computer 110 may then initiate a set of administration network advertising program instructions.

The administration database 130 may store data received from various third parties (various sellers) that are part of a set of MLM trees. This data may contain an item ID, description of the item, an original cost of the item, a discount for the item, a cost of the item with the discount, a compensation plan decay rate, and a link to the item. An advertising link may refer to a link that directs a consumer to a product, service or good.

TABLE 1
Administration Database Data

| third party | Home Depot | Home Depot | Furniture Store |
|---|---|---|---|
| ID | 654123 | 789654 | 123789 |
| Item | Drill | Table Saw | Couch |
| Original Cost | $59.00 | $119.00 | $999.00 |
| Discount | 15% | 10% | 10% |
| Discount Cost | $50.15 | $107.10 | $899.10 |
| Compensation | 50% | 50% | 30% |
| Decay Rate | | | |
| Link | HDDrill654123 | HDTSaw789654 | FSC123789 |

Table 1 displays data that may be stored at the administration database 130 of FIG. 1. When the administration network computer 110 receives item data from third party network computer 160 it creates a link for the item, stores the received data in the administration network administration database 130, and sends the created link back to the third party network computer 160. The administration network administration database 130 may be used to store data collected from various third parties that enrolled in the multi-level marketing system 100 of FIG. 1. The administration network administration database 130 may store the name of the third party, the ID for an item, a description of the item, the original cost of the item, the discount provided by the third party, the cost of the item with the discount, the compensation decay rate or how the downline commissions are calculated, and the link to the item.

The administration database 130 may store data that the administration network computer 110 may access when communicating events with the downlines and uplines, providing dynamic incentives or rewards for a product, distributing marketing materials, providing banking referrals, or distributing materials for suggestive selling, etc. Here, communicating events with downlines and uplines may refer to sending information relating to advertising events to participants of an MLM system. Dynamic incentives and rewards for a product may refer to incentives or rewards that are continuously updated for a product. Marketing materials may refer to a means of marketing, advertising or promotional materials developed by or for license (or subject to licensee's approval) that promote the sale of the licensed product, including but not limited to, television, radio and online advertising, point of sale materials (e.g., posters, counter-cards), packaging advertising, print media and all audio or video media. Banking referrals may refer to a structured flow of collecting and organizing referrals for banks. Businesses who have been unsuccessful in a credit application process with a bank may be asked for their permission to have their financial information passed to designated finance platforms who can contact the business in a regulated timeframe. Suggestive selling may refer to a sales technique where an employee asks a customer if they would like to include an additional purchase or recommends a product which might suit the client.

As mentioned above user device 140 may include a memory, a processor, and a communication interface 150. The processor of user device 140 may execute instructions out of the memory when a user of user device 140 registers as a member of an MLM organization. Other tasks that a user may perform on user device 140 could include, identifying or connecting with other user devices (e.g. follower user devices), preparing advertisement information to share with follower user devices, receiving advertisement information prepared by other users, accessing product promotions at the third party network computer 160, and purchasing products based on offerings received from the third party network computer 160. Each of the tasks performed by user device 140 may include sending and receiving communications with the administration network computer 110, the third party network computer 160, or other user devices. Promotions prepared at a particular user device may be shared with other user device via administration network computer 110, third party network computer 160, a social media network computer, or directly from one user device to another. User devices may also be required to download and install an application program from an application store, such as the “Apple App store” as part of a process for registering as a member of an MLM organization.

The user device communication interface 150 of FIG. 1 may send and receive data via a communication network 190 which may be a wired and/or a wireless network.

As discussed above the third party network computer 160 of FIG. 1 may include a computer processor a memory, and communication interface 170. This third party network computer 160 may be controlled by various third parties, such as retail stores (stores that sell product consumables, services, franchises, service networks, large box stores) or e-commerce sites that allow e-commerce sales. Such e-commerce sites may include an e-commerce shopping cart, that offer items to users at a discount, such as a product discount, in order to use the MLM system of FIG. 1. A franchise may refer to an authorization granted by a government or company to an individual or group enabling them to carry out specified commercial activities, e.g., providing a broadcasting service, or acting as an agent for a company's products. Product consumables may refer to goods by individuals and businesses that must be replaced regularly because they wear out or are used up. Service networks refer to a collection of people and information brought together on the internet to provide a specific service or achieve a common business objective, such as Angie's List. E-commerce sale may refer to sales of goods and services where the business takes place over the internet, an extra-net, Electronic Data Interchange (EDI), or other online system.

Payment may or may not be made online. Business in this context may be defined as an order placed by the buyer or price and terms of sale negotiated. E-commerce shopping cart may refer to a software used in E-commerce to assist visitors to make purchases online. Upon checkout, the software calculates the total of the order, including shipping and handling, taxes and other parameters the owner of the site has previously set. Retailer may refer to a person or business that sells goods to the public in relatively small quantities for use or consumption rather than for resale. Product discounts may refer to a reduced price or something being sold at a price lower than that item is normally sold for. It is a reduction to a basic price for a good or service. Large box stores may refer to a physically large retail establishment, usually part of a chain of stores, offers a variety of products to its customers. The term sometimes refers, by extension, to the company that operates the store, and which may be referenced as a supercenter, superstore, megastore, etc. These stores achieve economies of scale by focusing on large sales volumes. Because volume is high, the profit margin for each product can be lowered, which results in very competitively priced goods. The term “big-box” is derived from the store's physical appearance.

The third party network communication interface 170 of FIG. 1 may send data and receive via a communication network 190 which may be a wired and/or a wireless network.

The third party network discount program instructions 180 of FIG. 1 may be executed by a computer processor after being initiated by a set of third party network base program instructions. These instructions may cause the processor at the third party network computer 160 to prompt a user for a discount code and to compare a received code to data stored at a third party network third party database. When a code received from a user matches data stored at the databases, a discount for the selected item may be applied and an order for a product may be processed.

The communications network 190 of FIG. 1 may be the Internet or a cloud computing network. This communication network or any of the communication network interfaces 150 or 170 discussed herein may be a wired and/or a wireless network. Such a communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance.

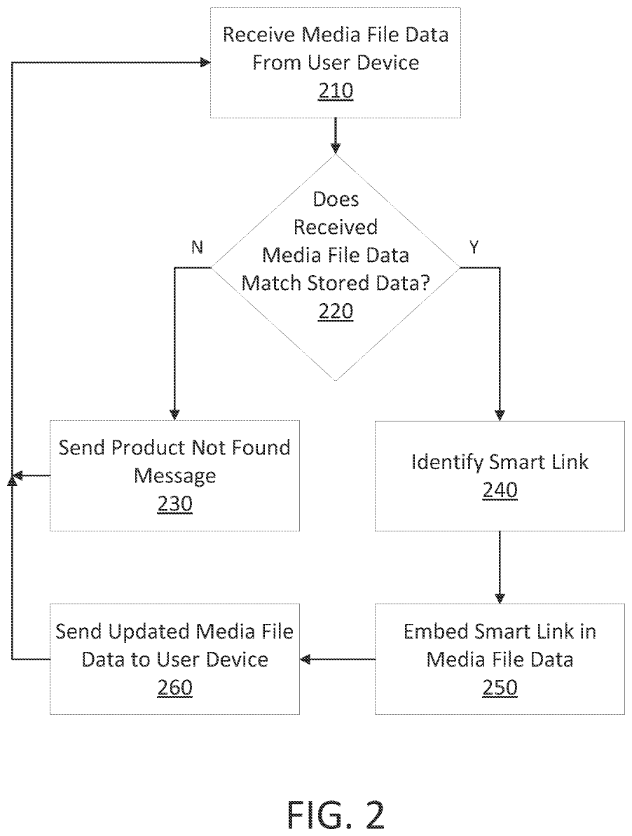

FIG. 2 illustrates steps that may be performed by an administration computer that receives media file data from user devices after members of a multilevel marketing system have generated content to share with others. This administration computer may be a computer at admin network 100 of FIG. 1. Media file data may include any type of multimedia data (e.g. a video clip) created by a member of the multilevel marketing system. A computer that performs administration functions of a product based multilevel marketing and sales system (such as computer of admin network 100 of FIG. 1) may be configured to receive multimedia data from user devices. This media file data may be received from a user device after a user generates that media file data. This media file data may include images of a product from which that product may be identified or may include other information used to identify the product. For example, a user may take an image of them wearing a product or take a video of them using a product. This media data may also include other types of information, such as text or audio information that explains how to use or purchase a product or this media data may include links that allow a user device to connect to a website that sells the product.

FIG. 2 begins with step 210 where media file data may be received from a user device. This media file data may be received after audio/video data has been collected or recorded at the user device. This media file data may be received based on an administration computer polling the user device for media file data or this data may be received based on user inputs (e.g. via a user interface) that commands the media file data to be sent to the administration computer. The received media file data may be associated with information that identifies the user, such as a user identifier (ID) code, a product identifier (ID), and a follower code (e.g. a code that will be shared with followers). These associations may be made at the user device, at an administration computer, or at both the user device and administration computer. The media file data received in step 210 may include a follower code, such as the follower code discussed in respect to table 2 of this disclosure, or this follower code may be assigned based on products included in or identified by data in the received media file.

Table 2 illustrates that a particular follower code (“code for followers”) may be associated with the user ID, a product identifier (ID), an item description, and a sphere of influence. Note that table 2 cross-references the same product identifier to different follower codes and different user identifiers. The data of table 2 shows that drill 654123 is associated with user ID JS1234 (first participant) and with follower code 654123-S012 and that drill 654123 is associated with user ID HY8569 (2^{nd} participant) and with follower code 654123-S013. Because of this table 2 identifies that user JS1234 purchased drill 654123 and then shared information relating to that purchase with user HY8596 who purchased drill 654123 based on the information that user JS1234 shared with user HY8596.

After the media file data is received in step 210 of FIG. 2, program flow moves to determination step 220. Determination step 220 may identify whether the received media file data matches data accessible by the administration computer. Determination step 220 may include comparing information in the received media file data with information stored at a database (e.g. administration database 120 of FIG. 1). This comparison process, for example, may include identifying that an image of a product or item included in the media data includes features of a product or item sold by a multilevel marketing organization. A media file received in step 210 of FIG. 2 may include a video, a picture/image, text, sound, haptic data, or other type of media file data.

In certain instances, the steps of FIG. 2 may be performed by a computer executing instructions of one or more software modules. For example, instructions of a single software module or instructions of several different software modules stored in a memory at an administration network computer. Functions performed by such an administration computer may include identifying a type of media file sent from a user device by identifying a file extension associated with the media file. One of ordinary skill in the art would understand that a file extension is a group of characters located a period in a file name identify a format of the file. For example, a video file may have the file extensions of “.webm”, “.mkv”, “.flv”, “.mov”, or “.qt”, etc. An image file may have file extensions of “.jpeg”, “.png”, “.gif”, “.tiff”, etc. A text file may have the file extensions of “.txt”, “.docx”, .pdf”, or an e-mail may be identified by the extension “.msg”. By locating the file extension of the received media file from a user device, an administration computer can identify what type of media file was received from the user device in step 210 of FIG. 2 (e.g. a video file, an image file, a text file, an e-mail file, etc.). As discussed above after the media file data has been received, determination step 220 may identify whether information included in the received media file data matches stored data.

The comparison and matching of media file data with stored data may use image recognition techniques of various sorts to find an appropriate matching item or product by comparing the received image to the images stored in the administration network database 120 of FIG. 1. Image recognition may be performed by a processor that executes instructions out of a memory. This may allow the processor to identify an object, a product, or other content included in a digital image or video after which, the processor may identify whether items in received data matches data associated with items sold by an MLM network. When determination step 220 identifies that the received data does not match the stored data, program flow may move to step 230 where a message indicating that the product was not found may be sent to the user device. Such a product not found message may identify that items included in a set of media file data does not match data stored at a product database.

After step 230, program flow may move back to step 210, where additional media file data may be received from the user device. Exemplary messages that may be sent to the user device in step 230 may include text or audio data that recite or state “product not found” or “please use another media file”, etc. When determination step 220 identifies that the features in the received media file data match stored data, program flow may move to step 240 of FIG. 2. Step 220 may identify a product based on comparing features in an image in a manner similar to a facial recognition process or by using a form of artificial intelligence (AI) software. Alternatively, the product may be identified by images of a bar code, text information, or other product identifying information that may have been received in or with the media file.

Various techniques may be used to identify a product that the user wishes to advertise. In such an instance, a user generated a media file may include, for example: 1. an image of the product alone (or a label that has information that identifies the product, such as a part number and manufacturer); 2. an image of the product and a separate image that includes the product and other content; 3. a combined image that includes the product and other content; or 4 a combined image that includes the product and the other content, where the product is identified by a marker or tag. In the first instance and the second instance above, the image of the product sent to the administration computer could be used by the administration computer to identify the product and to identify webpages where that product may be purchased. In the second instance, the administration computer could embed a link within the combined image. In the third instance, one or more products in the media file may be identified by pattern recognition or artificial intelligent (AI) software at the administration computer without requiring an independent image of the product or some other identifier that identifies the product.

In the fourth instance above, the user may have placed a marker or tag on the product such that the administration computer can more easily identify the product. This marker or tag may be used by the administration computer to identify the product and a related webpage. The administration computer may then embed a link (e.g., a smart-link) within the combined image that points to the webpage. This marker or tag may be a visual element attached to a product, such as a sticker or pin that has distinctive content that the administration computer may use to identify the product. Alternatively, this marker or tag may be a digital tag that is attached to the image. Such a digital tag may or may not be visible in the image. A visible digital tag may appear similar to the visual element discussed above or a non-visible tag may be comprised of data embedded in the media file as metadata or hypertext that identifies one or more products based on a location, for example.

When the media file includes an image of a hat, a type and style of the hat may be identified by the processor. The processor may then execute instructions to access data at a database to identify affiliated websites or webpages where the hat can be purchased. The instructions executed at the administration network computer may be instructions consistent with a form of AI or pattern recognition software.

As discussed above, such embedded links or smart-links may be used to direct followers or others to a webpage where they can purchase the advertised product. Codes (such as the aforementioned follower codes) associated with these links may be used to identify that a particular product has been shared by a particular user. Because of this, followers that receive media files from a user may not receive or be aware of the user ID or contact information of a user associated with the code and the product. Because of this, these codes may add an additional layer of security.

Once the administration network computer receives the media file, a processor at the advertising computer may execute instructions to identify or recognize one or more products included in or identified in the media file. Here the processor may execute instructions to identify the products in the media file using any of the techniques described above. For example, when the product that the user wishes to advertise is a hat, the administration computer could evaluate an image of the hat when identifying a type of hat and when identifying a webpage that may be accessed to purchase that hat. The image of that hat may then be sent back to the user device including a link to the webpage.

Step 240 of FIG. 2 is a step where this webpage link or smart link may be identified. Step 240 may also include extracting link information from a database, such as the administration network database 120 of FIG. 1. This smart link information may be copied such that it may be embedded into the received media file data. The identification or generation of this smart link may include steps of accessing information stored in a database that identifies the product, identifying locations where the product is offered for sale (e.g. at an online store), and creating a hyperlink that points to the product offering.

The smart link identified or generated in step 240 may then be embedded into the media data file received in step 250. This link may point to a website page or URL that sells the product at a discounted price. The embedding of this hyperlink in step 250 of FIG. 2 may be accomplished by using an “href” function within the html code that allows program code (e.g. instructions of with the admin network smart link, module 120 of FIG. 1) to take the link stored at the network administration database 112 and place it in the html code.

Steps 240 and 250 of FIG. 2 may involve the use or creation of what is commonly referred to as an anchor hyperlink. Anchor hyperlinks may be bound to a portion of a document or image. These anchor hyperlinks may include or be associated with text, a product name, or image of a product or object. While, anchor hyperlinks are generally used in areas of text documents, they also may be associated with a designated area of an image. Areas where anchor hyperlinks are embedded in an image may be defined by a list of coordinates that define boundaries of a specific anchor hyperlink. Because of this, a single image may include multiple embedded hyperlinks. In such an instance, each individual embedded hyperlink could be associated with a different area of the image, each of these hyperlinks could be associated with a different product, and each of these embedded hyperlinks may point to a different website or a different webpage of a website.

Each specific anchor hyperlink could include or be associated with html code that points to a website and could be associated with a user ID, a follower ID, and a product ID. Because of this, the media file data may be associated with a user of the user device from which the media file data was received. In instances when the user is not currently associated with a follower ID, a follower ID could be associated with the user and this information may be stored in a database at or accessible by a computer at an administration network. In certain instances, the media file data itself may also be stored at the administration network database.

Next in step 260 an updated media file with the embedded smart link for the product or item may be sent back to the user device. The media file data sent to the user device may also identify the user ID, the product ID, and the follower code. After step 260, program flow may move back to step 210 of FIG. 2 where additional medial file data may be received from the user device.

After the media file data has been received at the user device, it may be shared with followers of the user. This sharing may allow a person on social media to click on a location where the anchor hyperlink has been embedded and their browser may be redirected to an offering for the product advertised in the shared media file. Once embedded into a shared document, image, or video, a person could simply click on a portion of the document, image, or video provided via a social media site and that person's web browser may be redirected to a webpage that advertises the particular product identified in the document or included in the image or video. As mentioned above, instead of pointing and clicking using a device such as a computer mouse, products may be selected by a user touching an image of a product in a touch screen display.

TABLE 2
Code Database Data

| | | | Sphere of Influence/ | |
|---|---|---|---|---|
| | | | potential purchaser/ | code for |
| user ID | ID | Item | distributor | Followers |
| JS1234 | 654123 | Drill | First Participant | 654123-SOI2 |
| HY8569 | 654123 | Drill | Second Participant | 654123-SOI3 |
| TB4567 | 789654 | Table | First Participant | 897456-SOI2 |
| | | Saw | | |
| EL51346 | 789654 | Table | Second Participant | 897456-SOI3 |
| | | Saw | | |

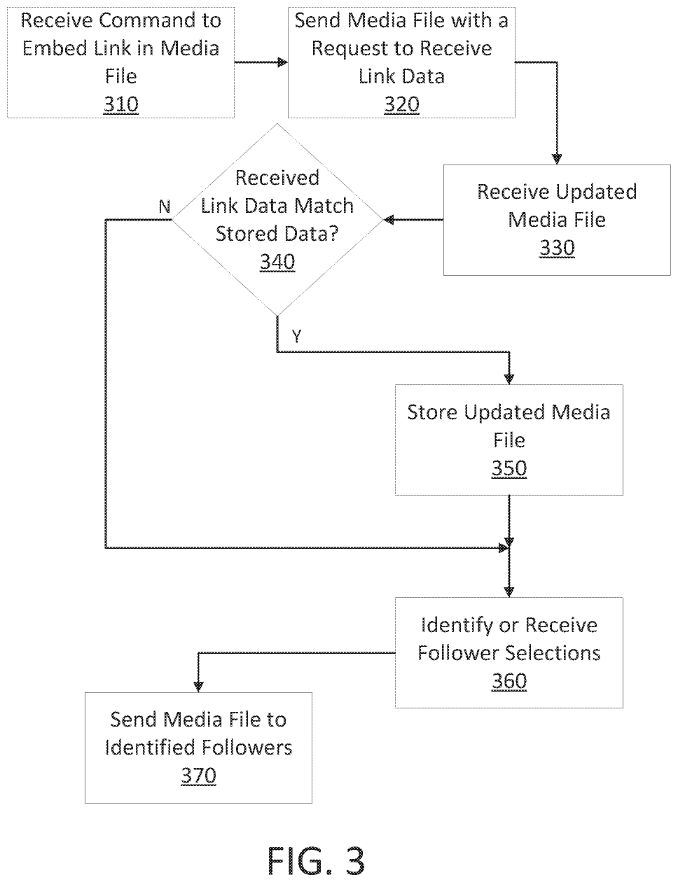

FIG. 3 illustrates actions that may be performed when a user wishes to include hyperlinks in a media file or when the user wishes to update hyperlinks in a media file. The steps illustrated in FIG. 3 may be performed by a user device that communicates with an administration computer such as the admin network 100 computer of FIG. 1. This may be part of a process that allows a user to sell a product associated with a multilevel marketing (MLM) network. The process may include receiving a command that identifies that a link should be embedded in a particular media file in step 310 of FIG. 3. This command may be received from a user interface at the user device after a user has made one or more selections in that user interface. These selections may be included in a command sent to the administration computer when that user wishes to embed a smart-link into the media file so that the media file alone can be used to advertise a product to their followers (“downline distributors”). This media file may include text, audio, photos, and/or videos generated by the user when that user wishes to advertise and sell a product offered for sale by a seller associated with the MLM network. The steps of FIG. 2 and FIG. 3 may be associated with a user device that implements the steps of FIG. 3 and an administration computer that implements the steps of FIG. 2.

The media files discussed herein may have been generated after a user has purchased a product and after that user has become a registered user (or distributor) of an MLM network. Here again, a code may be associated with a generated media file. The code associated with the media file may be assigned at an administration network during part of a registration process of the user or as part of a process that associates the user with the product. In certain instances, this code may be assigned at a point in time after the media file has been sent to the administration network. This code may be the follower code discussed in respect to table 2 and FIG. 2 of this disclosure.

In instances when a user wishes to provide images in a media file, one or more techniques may be used to identify a product that the user wishes to advertise. In such an instance, a user may generate a media file that includes, for example: 1. an image of the product alone (or a label that has information that identifies the product, such as a part number and manufacturer); 2. an image of the product and a separate image that includes the product and other content; 3. a combined image that includes the product and other content; or 4 a combined image that includes the product and the other content, where the product is identified by a marker or tag. In the first instance and the second instance above, the image of the product sent to the administration computer could be used by the administration computer to identify the product and to identify webpages where that product may be purchased. In the second instance, the administration computer could embed a link within the combined image. In the third instance, one or more products in the media file may be identified by pattern recognition or artificial intelligent (AI) software at the administration computer without requiring an independent image of the product or some other identifier that identifies the product.

In the fourth instance above, the user may have placed a marker or tag on the product such that the administration computer can more easily identify the product and based on this marker or tag the administration computer could identify the product, a related webpage, and embed a link within the combined image that points to the webpage. This marker or tag may be a visual element, such as a sticker or pin that has distinctive content that the administration computer may use to identify the product. Alternatively, this marker or tag may be a digital tag that is attached to the image. Such a digital tag may or may not be visible in the image. A digital tag may appear similar to the visual element discussed above or it may be comprised of data embedded in the media file as metadata or hypertext that identifies one or more products based on a location, for example.

When the media file includes an image of a hat, for example, a type and style of the hat may be identified by the processor. The processor may then execute instructions to access data at a database to identify affiliated websites or webpages where the hat can be purchased. The instructions executed at the administration network computer may be instructions consistent with a form of AI or pattern recognition software.

As discussed above, such embedded links may be used to direct followers or others to a webpage where they can purchase the advertised product. Codes (such as the aforementioned follower codes) associated with these links may be used to identify that a particular product has been shared by a particular user. Because of this, followers that receive media files from a user may not receive or be aware of the user ID associated with the code and the product. Because of this, these codes may add an additional layer of security. Next in step 320 the media file may be sent as part of a request to the administration computer, that once again may be a computer at administration network 100 of FIG. 1.

Once the administration network computer receives the media file, a processor at the advertising computer may execute instructions to identify or recognize one or more products included in or identified in the media file. Here the processor may execute instructions to identify the products in the media file using any of the techniques described above. When the product that the user wishes to advertise is a hat, the administration computer could evaluate an image of the hat when identifying a type of hat and when identifying a webpage that may be accessed to purchase that hat. The image of that hat may then be sent back to the user device including a link to the webpage.

In the instance where the media file includes an image of the hat and a combined image (that shows the user wearing the hat), the administration computer may send an updated media file back to the user device. This updated media file may include both of the images or may include only the combined image that includes link to the webpage embedded in the image sent to the user device. In the third instance, the AI or pattern recognition software executed by a processor at the administration computer alone would identify the hat. In the fourth instance discussed above, the administration computer could identify the hat based on a marker being attached to the hat. The administration computer could identify the hat and the related webpage, could digitally remove (computer edit) the marker from the hat, and then send an updated image including an embedded link to the website back to the user device.

Steps 310 and 320 of FIG. 3 discussed above may have been performed based on one or more selections entered by a user of a user device, for example, by selecting a “embed smart link” button on a user interface. In some embodiments, a user interface may either accept inputs from users or provide outputs to the users or may perform both the actions at a user device. In one case, a user can interact with the interface using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, a user interface may either be implemented as a command line interface (CLI), a graphical user interface (GUI), a voice interface, or a web-based user-interface.

After the administration computer sends the updated media file to the user device, that updated media file be received by the user device in step 330 of FIG. 3. Next, determination step 340 may identify whether links embedded in the media file match stored data. In certain instances, the updated media file may include a follower code and the link that was embedded into the media file by the computer at the administration network. Determination step 340 may identify whether there is a local media file with an embedded smart link for the same product as the received link. Determination step 340 may compare any program code or link information included in the stored data with data included in the updated media file received in step 330. For example, when an image file stored at the user device and the updated media file include an identical hyperlink, a processor at the user device may execute instructions to perform one or more pre-programmed or pre-selected tasks not illustrated in FIG. 3. In certain instances, actions performed when there is a match could be based on user selections or settings that may have been set by a user. Various tasks that could be performed when there is a match could include any of: 1. Prompt the user to select whether to share the stored media file or to share the updated media file received in step 330; 2. Share the stored media file based on a setting; or 3. Share both media files.

When determination step 340 identifies that the updated media file should be shared or otherwise used, program flow may move to step 350, where the updated media file is stored in memory or database at the user device. After step 350 or immediately after step 340, program flow may move to step 360 where followers of the user may be identified or selected. Step 360 may send a media file advertising a product to all of their followers or a user may be able to select which of their followers to which the media file may be sent. As discussed previously, the user and the user's followers (“downline distributors”) may be part of a multi-level marketing organization that share commissions according to a commission schedule when advertised products are purchased. After the followers are identified or selected in step 360, program flow may move to step 370 where the media file with embedded links may be sent to the identified or selected followers.

In certain instances, followers to send particular types of products to may be identified based on a preset criterion or set of rules. A set of rules could identify followers that enjoy certain types of activities, types of food or restaurants, or a rule may identify a customer demographic (age, sex, income, residence location, education level, home ownership status, or other demographic criteria). Followers that match a set of criteria according to a set rules may be identified in step 360, such that only those identified matching followers will be sent the media file in step 370. For example: only followers identified as being skiers may be sent media files advertising skiing equipment or skiing related vacation offers, only followers identified as being home owners may be sent media files including offers regarding household products or services, or only followers that like to read romance novels may be sent media files advertising a new romance novel (e.g. a book, books on tape, or an electronic book).

TABLE 3
User Media Database Data

| Third Party | Home Depot | Home Depot | Furniture Store | Pharmacy |
|---|---|---|---|---|
| Product | 654123 | 789654 | 123789 | 456812 |
| Identifier | | | | |
| Product | Drill | Table Saw | Couch | Cold Medicine |
| Description | | | | |
| Original | HDDDrill654123.jpg | Newtablesaw.mov | Couch_song.mp3 | PColdMed456812.png |
| Media File | | | | |
| Embedded | HDDrill654123.html | Newtablesaw.html | Couch_song.html | PColdMed456812.html |
| File | | | | |
| Original | $59.00 | $119.00 | $999.00 | 25 |
| Cost | | | | |
| Discount % | 15% | 10% | 10% | 5% |
| Discount | $50.15 | $107.10 | $899.10 | $23.75 |
| Cost | | | | |
| Comm. | 50% | 50% | 30% | 50% |
| Decay Rate | | | | |
| Link | HDDDrill654123 | HDTSaw789654 | FSC123789 | PCM456812 |
| Smart-Link | SLHDDrill654123.data | SLHDDrill654123.data | SLFSC123789.data | SLPCM456812.data |

Table 3 illustrates data that may be stored at a user device, at an administration network or both. The data of table 3 cross-references products offered for sale by different third party vendors with other information. The data of table 3 includes a product identifier (ID) number, a product description, an original media file associated with a given product, an embedded file, an original cost to purchase the product, a discount percentage (%), a discount cost, a commission decay rate, a link to the product, and a smart-link associated with the product. Note that media files identified in table 3 are of different types, a .jpg file associated with a JPEG image/photo of a product, a .mov file associated with a movie (i.e. audio/video) that includes the product, an mp3 file that stores audio information about a product, and a .png file that stores graphical data about a product. Note also that the embedded files included in table 3 are .html (hypertext markup language) file pointers that may point to media files created by a user of an MML organization.

The cost and discount information of table 3 identifies original costs, discounts, and discounted costs related to a product. Note that members of the MLM may purchase drill that usually is sold for $59.00 for $50.15 based on a 15% discount being associated with drill 654123.

The compensation decay rate of table 3 includes commission (or compensation) rate decays of 30% and 50% depending on a product. This means that when a commission decay rate is 50% and when a commission paid to a first tier user of an MLM organization is $1.00, a second tier user would receive fifty cents ($0.050), and a third tier user would receive twenty-five cents ($0.25).

The link data of table 3 may point to a corresponding original media file. For example, link HDTSaw789654 may point to the original media file Newtablesaw.mov. The smart-link data of table 3 may be pointed to by the .html data included in an embedded image. For example, clicking on an image of drill 654123 could cause .html code to be executed that points to the smart-link SLHDDrill654123.data.

Table 4 illustrates data that may be stored at a user device user database. The data of table 4 cross-references user information with user follower information. The user device user database stores the user's ID, the followers user ID, codes provided to the followers, the follower's e-mail address, the follower's phone number, and the follower's address. The user device user database may store the follower's social media information such as user social media account information (Twitter, Instagram, Facebook, etc.). The user database may contain social media plug-ins for enhanced marketing or social media aggregators. Social media plug ins for enhanced marketing may refer to sharing content with other people through social media platforms, for example a share or like button. The user device user database may contain payment information such as bank accounts, credit card information, PayPal, Venmo, etc. A user ID or ID Enrollment may refer to a participant enrolling in an MLM product tree through an ID, which may be unique to each participant in the MLM system. Social media aggregators may refer to a tool that allows a person to collate posts and updates from many different social media feeds. It creates an organized view of social posts on a specific topic and are often used to display user-generated content on live social walls.

TABLE 4
User Database Data

| | | | |
|---|---|---|---|
| User ID | JS1234 | JS1234 | JS1234 |
| Follower ID | HY8569 | IT8527 | RW4569 |
| Follower Codes | 654123-SOI2 | 654123-SOI2 | 654123-SOI2 |
| Follower E-mail | HY8569@gmail.com | IT8527@yahoo.com | RW4569@gmail.com |
| Follower Phone | 781-654-8972 | 231-456-7891 | 654-987-3217 |
| Follower | 123 Main Street, | 58 Elm Street, | 96 2nd Ave, Salt |
| Address | Boston, MA | Burlington, VT | Lake City, UT |

Operation of user device downline program instructions may cause the user device 140 to continuously poll to receive the code and link from the administration network computer 110 to allow the purchaser/distributor to pass the code and link to the user's followers stored in the user device user database. Functioning of the downline program instructions may be as follows. The process begins with the user device 140 continuously polling for the code and the link from the administration network computer 110. The user device 140 receives the code and the link from the administration network computer 110. The user device 140 provides a selection of the first follower in the user device user database. The user device 140 extracts the followers contact information stored in the user device user database. Then the user device 140 sends the code and link to the follower's contact information. The code and link may be shared on social media sites, such as Twitter, Instagram, Facebook, etc. This process may include sharing of the media files created by users that shared product information to their followers and this may allow the user's followers to receive the code and link based on communications that use one or more of these social media accounts. The user device 140 may then determine if there are more followers remaining in the user device user database. If it is determined that there are more followers stored in the user device user database, the user device 140 selects the next user stored in the user device user database. If the user device 140 determines that there are no more followers remaining in the user device user database, then the process ends.

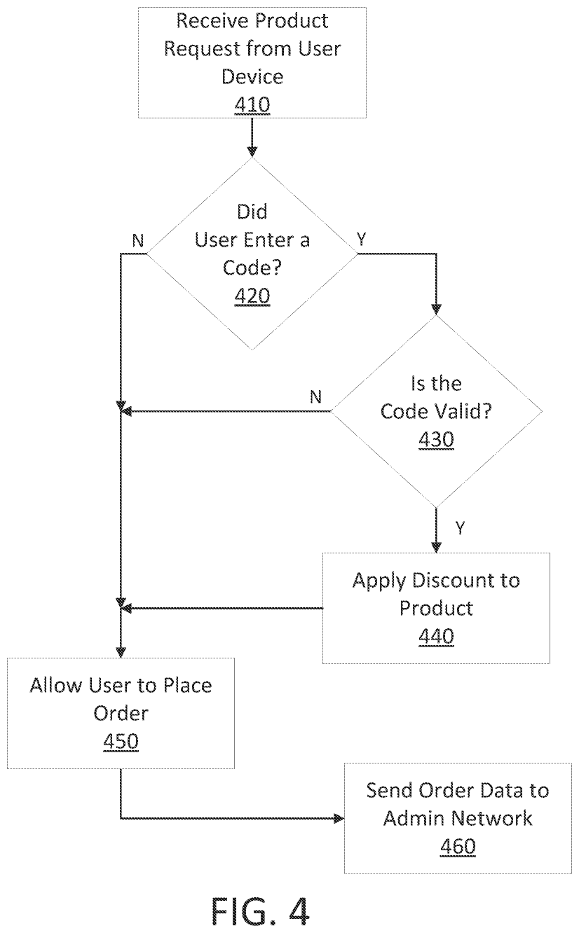

FIG. 4 illustrates steps 400 that may be performed by a computer at the third party network computer 160 of FIG. 1. FIG. 4 begins with step 410 wherein the third party network computer 160 receives a request from a user device 140 to purchase a product. This request may be facilitated by a public facing webpage, for example, an online store page for the third party retailer that controls the third party network computer 160. The third party network computer 160 then may identify if the user entered a code, at step 420. Here, the code may be entered prior to a request for purchase. For example, before checking out using an online shopping cart the user may be able to enter discount codes. If a code was entered, program flow may move to determination step 430 and the third party network computer 160 may identify whether the code is recognized as a valid code for receiving a discount, at step 430 of FIG. 4.

The code may be retrieved from the administration network computer 110 via the third party network communication interface 170. Codes may be stored locally on the third party network computer 160 or in a third party network third party database accessible by the third party network computer. If the code is valid, the third party network computer 160 applies a discount to the item, at step 440. An amount associated with this discount may be retrieved by the administration network computer 110 via the third party network communication network interface 170. Discount amounts may be stored locally at a third party network database. The third party network computer 160 may then allow the user to finish placing the order for the item, at step 450 of FIG. 4. The third party network computer 160 may then send some or all the data on the purchase, including the discount code if one was provided, to the administration network computer 110, at step 460. Any or all these steps may also be facilitated by execution of different sets of program instructions that may include: third party network base program instructions and third party network administration program instructions.

A third party network computer 160 may execute administration program instructions to cause the third party network computer to connect to the administration network computer 110, send the data for the items to be purchased, receive a link from the administration network computer 110, store the link in a third party network database, and return to executing a set of base program instructions. The process may begin with the third party network computer 160 administration program instructions being initiated by the third party network base program instructions. The third party network 160 may connect to the administration network computer 110 and then the third party network computer 160 may send third party network database data to the administration network computer 110. Then, the third party network computer 160 may store the link in the third party network third party database.

Operation of a third party network discount program instructions 180 may include extracting a link sent by the user device 140 and comparing it to data stored at the third party network third party database. This may result in the identification of a corresponding discount for a selected item. This process may include identifying whether a user entered a code or not, after which a discount is applied and the order is processed.

The process of applying a discount may begin by extracting the link received from the user. Then the third party network computer 160 may compare data included in the extracted link to data stored at the third party network database. The third party network computer 160 may then extract a corresponding discount from the third party network third party database. Then the third party network computer 160 may apply the extracted discount to the user's order. The third party network computer 160 may then determine if the user entered a code. If it is determined that the user did not enter a code the third party network computer 160 sends the user data to the administration network computer 110 without a code. If it is determined that the user entered a code the third party network computer 160 sends the code and the user data to the administration network computer 110. Next the third party network computer 160 may process the user's order.

A third party network third party database may store information about the items that may be purchased. This the third party network database may include local media for the product or service, where this local media may refer to the various types of media, such as photos, videos, text, sounds, haptics, online product descriptions, etc. for enhanced marketing.

Table 5 illustrates data that may be stored at a third party database. This data may include information about the items enrolled in the MLM system as well as a link created by execution of the administration network vendor program instructions. The third party network database may cross-reference an item ID, an item description, an original cost of the item, a discount provided by the third party for the item, a cost of the item with the discount, a compensation plan decay rate which the third party enters, and a link received from the administration network computer. The third party network third party database may include the rates of exchange for product returns, marketing materials, airline sky miles, etc. Product returns may refer to a process in which a customer or consumer takes previously purchased product, merchandise, or goods back to the retailer, and in turn receive a refund in the original form of payment, exchange for another item (identical or different), or a store credit.

The information about the product or service which may be advertisements to the network, or as seen on TV sales. Advertisements to the network may refer to the advertisement provided to the MLM system from the third party offering a product, good or service. These as seen on TV sales may refer to a generic nameplate for products advertised on television in the United States for direct response mail-order through a toll-free telephone number. Marketing materials may refer to a means of marketing, advertising or promotional materials developed by or for license (or subject to licensee's approval) that promote the sale of the licensed product, including but not limited to, television, radio and online advertising, point of sale materials (e.g., posters, counter-cards), packaging advertising, print media and all audio or video media. Airline sky miles may refer to a loyalty program offered by airlines and/or credit cards. Typically, consumers accumulate a set amount of miles based on how much is spent on a ticket or a credit card and are also known as frequent flyer miles or travel points.

TABLE 5
third party database Data

| | |
|---|---|
| ID | 654123 |
| Item | Drill |
| Original Cost | $59.00 |
| Discount | 15% |
| Discount Cost | $50.15 |
| Compensation Decay Rate | 50% |
| Link | HDDrill654123 |

FIG. 5 illustrates a computing system that may be used to implement an embodiment of the present invention. The computing system 500 of FIG. 5 includes one or more processors 510 and main memory 520. Main memory 520 stores, in part, instructions and data for execution by processor 510. Main memory 520 can store the executable code when in operation. The system 500 of FIG. 5 further includes a mass storage device 530, portable storage medium drive(s) 540, output devices 550, user input devices 560, a graphics display 550, peripheral devices 580, and network interface 595.

The components shown in FIG. 5 are depicted as being connected via a single bus 590. However, the components may be connected through one or more data transport means. For example, processor unit 510 and main memory 520 may be connected via a local microprocessor bus, and the mass storage device 530, peripheral device(s) 580, portable storage device 540, and display system 550 may be connected via one or more input/output (I/O) buses.

Mass storage device 530, which may be implemented with a magnetic disk drive—an optical disk drive—or FLASH memory, is a non-volatile storage device for storing data and instructions for use by processor unit 510. Mass storage device 530 can store the system software for implementing embodiments of the present invention for purposes of loading that software into main memory 520.

Portable storage device 540 operates in conjunction with a portable non-volatile storage medium, such as a FLASH memory, compact disk or Digital video disc, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Examples of suitable output devices include speakers, printers, network interfaces, and monitors.

Display system 550 may include a liquid crystal display (LCD), a plasma display, an organic light-emitting diode (OLED) display, an electronic ink display, a projector-based display, a holographic display, or another suitable display device. Display system 550 receives textual and graphical information and processes the information for output to the display device. The display system 550 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 580 may include any type of computer support device to add additional functionality to the computer system. For example, peripheral device(s) 580 may include a modem or a router.

Network interface 595 may include any form of computer interface of a computer, whether that be a wired network or a wireless interface. As such, network interface 595 may be an Ethernet network interface, a BlueTooth™ wireless interface, an 802.11 interface, or a cellular phone interface.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 500 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a FLASH memory/disk, a hard disk, magnetic tape, any other magnetic medium, a CD-ROM disk, digital video disk (DVD), any other optical medium, RAM, PROM, EPROM, a FLASH EPROM, and any other memory chip or cartridge.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The functions performed in the processes and methods which may be implemented in differing order. Furthermore, the outlined steps and operations are only provided as examples, and some of the steps and operations which may be optional, combined into fewer steps and operations, or expanded into additional steps and operations without detracting from the essence of the disclosed embodiments.

What is claimed is:

1. A method for distributing custom product links, the method comprising:
receiving an image of a product sent over a communication network from a user device associated with a user identifier (ID);
storing data that associates the user ID with the product and a follower code in a database;
generating an embedded link selectable to access online data regarding the product, wherein the embedded link further includes the user ID and the follower code;
sending the received data with the embedded link to the user device, wherein the user device initiates an order for the product using the embedded link; and
processing the order for the product, wherein processing the order includes distributing one or more commissions associated with the order based on the user ID and the follower code in the embedded link.

2. The method of claim 1, further comprising:
identifying the product; and
identifying the link to embed in the received data.

3. The method of claim 1, further comprising identifying a location of an image portion corresponding to the product, wherein the link is embedded at the identified location within the image.

4. The method of claim 1, further comprising identifying the follower code.

5. The method of claim 1, further comprising assigning the follower code, wherein the data sent to the user device includes the follower code.

6. The method of claim 1, wherein the received data includes the follower code.

7. The method of claim 1, further comprising identifying a set of features in the image, wherein the product is identified based on the identified set of features matching stored information regarding the product.

8. The method of claim 1, wherein processing the order includes identifying the user ID and the follower code based on use of the embedded link.

9. The method of claim 1, further comprising identifying a commission decay rate.

10. The method of claim 9, further comprising distributing information regarding the commissions over the communication network to user devices of at least two users according to the commission decay rate.

11. A non-transitory computer-readable storage medium having embodied thereon a program executable by a processor for implementing a method for distributing a product, the method comprising:
receiving an image of a product sent over a communication network from a user device associated with a user identifier (ID);
storing data that associates the user ID with the product and a follower code in a database;
generating an embedded link selectable to access online data regarding the product, wherein the embedded link further includes the user ID and the follower code;
sending the received data with the embedded link to the user device, wherein the user device initiates an order for the product using the embedded link; and
processing the order for the product, wherein processing the order includes distributing one or more commissions associated with the order based on the user ID and the follower code in the embedded link.

12. The non-transitory computer-readable storage medium of claim 11, further comprising instructions executable to:
identify the product; and
identify the link to embed in the received data.

13. The non-transitory computer-readable storage medium of claim 11, further comprising instructions executable to identify a location of an image portion corresponding to the product, wherein the link is embedded at the identified location within the image.

14. The non-transitory computer-readable storage medium of claim 11, further comprising instructions executable to identify the follower code.

15. The non-transitory computer-readable storage medium of claim 11, further comprising instructions executable to assign the follower code, wherein the data sent to the user device includes the follower code.

16. The non-transitory computer-readable storage medium of claim 9, wherein the received data includes the follower code.

17. The non-transitory computer-readable storage medium of claim 11, further comprising instructions executable to identify a set of features in the image, wherein the product is identified based on the identified set of features matching stored information.

18. The non-transitory computer-readable storage medium of claim 11, further comprising instructions executable to identify the user ID and the follower code based on use of the embedded link.

19. The non-transitory computer-readable storage medium of claim 11, further comprising identifying a commission decay rate.

20. The non-transitory computer-readable storage medium of claim 19, further comprising instructions executable to distribute information regarding the commissions over the communication network to user devices of at least two users according to the commission decay rate.
